(19) United States
(12) Patent Application Publication
(10) Pub. No.: US 2004/0193764 A1
(43) Pub. Date: Sep. 30, 2004

(54) PC card with standalone functionality

(75) Inventor: Hidekazu Watanabe, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation, Tokyo (JP); Sony Electronics Inc., Park Ridge, NJ

(21) Appl. No.: 10/402,730

(22) Filed: Mar. 27, 2003

(51) Int. Cl. G06F 13/12

(52) U.S. Cl. 710/62

(57) ABSTRACT

The present invention provides a PCMCIA card that includes a host device interface configured to interface with an external host device, an internal power source, an interactive output, and an interactive input. The PCMCIA card can additionally include a memory port configured to receive an external memory storage device. In some embodiments, the interactive output includes a display and/or an audio output. The PCMCIA card can additionally include a data processor configured to provide control over output directed to the interactive output, and an external interface controller configured to control data communication to and from the PCMCIA card. The external interface controller can include an external memory interface controller to control data communication between the PCMCIA card and an external memory storage device, and/or can include a network interface controller to control data communication between the PCMCIA card and an external network.

### BACKGROUND OF THE INVENTION

1. Field of the Invention

The present invention relates generally to a Personal Computer Memory Card International Association (PCMCIA) card or Personal Computer (PC) card, and more specifically a PC card configured with stand alone capabilities and functionality.

2. Discussion of the Related Art

A Personal Computer Memory Card International Association (PCMCIA) card or Personal Computer (PC) card is an input/output (I/O) or memory device that couples with a personal computer, often a portable computer, providing the computer with added functionality and/or memory.

PC cards are typically one of three physical sizes of cards: Type I, Type II, and Type III. All three types use the same 68 pin edge connector for attachment to the computer, and differ only in thickness. The thickness for Type I, Type II, and Type III are 3.3, 5.0, 10.5 millimeters respectively. Type I PC cards are typically used to provide memory enhancements. Type II PC cards provide memory enhancement or I/O features. Type III PC cards provide memory enhancements or I/O features that require larger size.

The functions and capabilities of the PC card are only realizable in cooperation with a host device, such as a computer. A host device is needed to access data or utilize the I/O functionality of the PC card.

### SUMMARY OF THE INVENTION

The present invention advantageously addresses the needs above as well as other needs by providing a Personal Computer Memory Card International Association (PCMCIA) card or Personal Computer (PC) card the provides stand alone functionality was well as providing additional or enhanced functionality to a host device.

In one embodiment, the invention can be characterized as a PCMCIA card that includes a host device interface configured to interface with an external host device, an internal power source, an interactive output, and an interactive input. In some embodiments, the PCMCIA card additionally includes a memory port configured to receive an external memory storage device. Further, in some embodiments, the interactive output includes a display for displaying at least a portion of data accessible through the PCMCIA card.

In another embodiment, the invention can be characterized as a Personal Computer Memory Card International Association (PCMCIA) card that includes a host device interface configured to allow the PCMCIA card to interface with a host device, a PCMCIA card output, a data processor configured to provide control over output directed to the PCMCIA card output, and an external interface controller configured to control data communication to and from the PCMCIA card. In some embodiments, the external interface controller includes an external memory interface controller configured to control the data communication between the PCMCIA card and an external memory storage device. Additionally or alternatively, the external interface controller can include a network interface controller configured to control the data communication between the PCMCIA card and an external network.

In a further embodiment, the invention may be characterized as an apparatus for interfacing with a host device. The apparatus includes a data processor configured to provide data processing within the apparatus, a host device interface, a direct apparatus output, and a functional input coupled with the data processor, wherein the function input directs at least a portion of the operation of the data processor. In some embodiments, the direct apparatus output includes an audio output and/or a display. The apparatus can further include an audio input.

A better understanding of the features and advantages of the present invention will be obtained by reference to the following detailed description of the invention and accompanying drawings, which set forth illustrative embodiments in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified elevated view of a Personal Computer Memory Card International Association (PCMCIA) card or Personal Computer (PC) card according to one embodiment of the present invention;

FIG. 2 depicts a simplified elevated view of a stand alone PC card according to one embodiment of the present invention;

FIG. 3 depicts a simplified block diagram of a PC card according one embodiment of the present invention, which can implement, for example, the PC card shown in FIG. 1;

FIG. 4 shows a simplified block diagram of a PC card according to one embodiment of the present invention for implementing a PC card similar to that shown in FIG. 2;

FIG. 5 depicts a simplified block diagram of an alternative embodiment of a PC card according to an alternate embodiment of the present invention for implementing the PC card shown in FIG. 2; and

FIG. 6 depicts a simplified block diagram of an alternative embodiment of a PC card according to one embodiment of the present invention for implementing the PC card shown in FIGS. 1 and/or 2.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

While the invention herein disclosed has been described by means of specific embodiments and applications thereof, numerous modifications and variations could be made thereto by those skilled in the art without departing from the scope of the invention set forth in the claims.

The use of Personal Computer Memory Card International Association (PCMCIA) cards or personal computer (PC) cards are commonly used in personal computers, such as portable or laptop computers, desk top computers and other computers. The PC cards provide additional functionality and/or memory for a computer. For example, PC cards can provide additional memory such as additional RAM memory and/or a disk drive (with one or more rotating disks), an interface (I/F) such as a modem, GPS, Bluetooth or LAN interface, a network adapter, a SCSI adaptor or other adaptors, and other similar functions. It is noted that the term PC card is utilized throughout the application to mean a PCMCIA card, a PC card or other similar devices.

However, previous PC cards cannot operate without interfacing or being accessed by a main module, equipment, host device or computer. For example, a previous PC memory card must be inserted into a computer, and the computer is utilized to access and/or view the data stored on the memory card.

Alternatively, the present invention provides a PC card that includes stand alone functionality. This stand alone functionality allows a user to utilize the PC card without having to interact with a host device (e.g., a portable computer). As an example, the stand alone PC card of the present invention can be configured as a memory storage device or memory card that allows a user to gain access to at least some of the data stored on the memory storage PC card without the need for the PC card to interact with a host device. However, the PC card of the present invention is additional configured to cooperate with a host device and to allow access and/or use of the PC card through the host device. The PC card of the present invention can be configured to be utilized with substantially any host device, such as laptops, notebooks, personal digital assistances (PDAs), tablets, digital gaming devices (e.g., PlayStation®, GameBoy®, etc.), personal computers and other host devices configured to utilize PC cards.

In some embodiments, the present PC card can be configured to provide any number of host device and stand alone enhancements, capabilities and functions. For example, the PC card can provide memory enhancements, including random access memory (RAM), FLASH memory, onetime programmable (OTP) memory, electronically erasable programmable memory (EEPROM), rotating mass storage, and other memory enhancements. Further, the PC card of the present invention can provide input/output (I/O) functionality, such as modems, LAN interfaces, host communications, other network interfaces, radio communications or other wireless communications, and other I/O functionality.

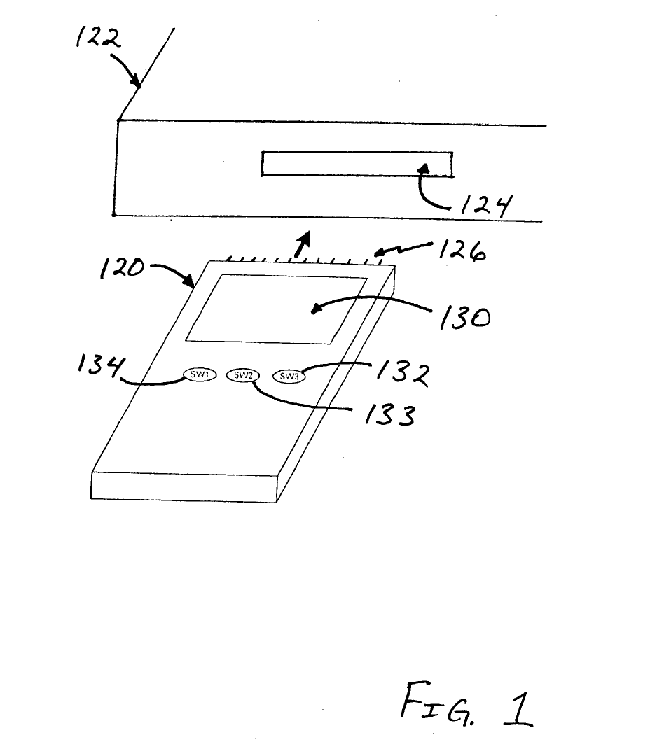

FIG. 1 depicts a simplified elevated view of a PC card 120 according to one embodiment of the present invention. The PC card 120 is configured to interface with a host device 122, such as a portable computer, a desktop computer, other portable computing devices, a camera, a PDA and other host devices that utilize PC cards. The PC card 120 can provide any number of functions and/or capabilities to the host device 122 including, but not limited to, additional memory, network interface, network adaptor, peripheral device adaptor and other similar functions. Typically, the PC card 120 is inserted into the host device 122 through a PC card slot or port 124. The PC card includes a host interface 126, which can be implemented through substantially any interface, such as a 68 pin male/female connector or other connectors. The host interface 126 allows the PC card to mate or interact with a receiving interface in the host devices 122.

The PC card 120 is configured to additionally provide stand alone operational functionality and/or capabilities. More specifically, the PC card 120 provides one or more direct or interactive PC card outputs. Examples of direct or interactive PC card outputs can include visual output, audio output and other similar outputs. In one embodiment, the active output of the PC card 120 includes a display device 130, such as a liquid-crystal display (LCD) or other similar display. The display 130 allows a user to interactively access and view data stored within the PC card 120. The data can be directly accessed and viewed on the display 130 without having to interact with the host device 122. This allows the PC card 120 to operate as a stand alone device as well as having the capability of cooperation with a host device adding flexibility of use and providing enhanced functionality.

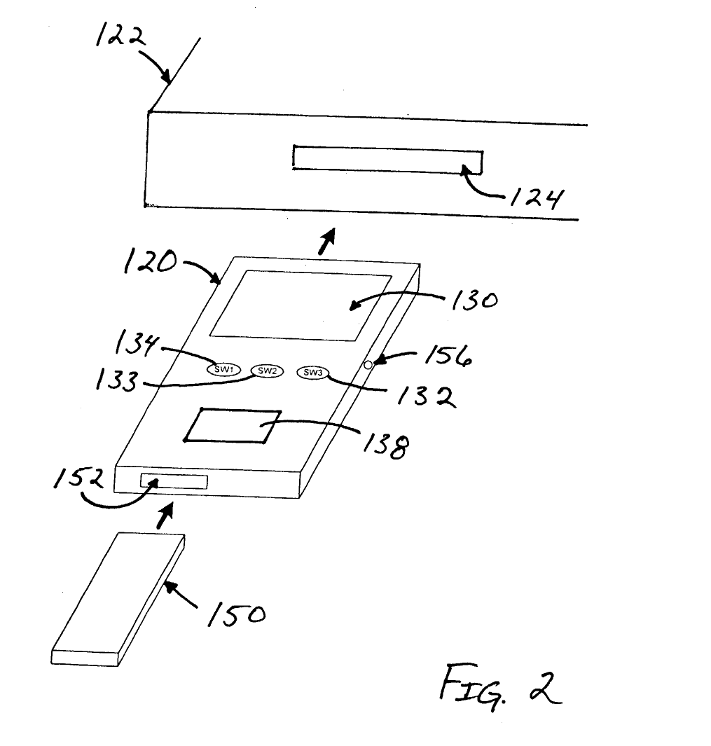

Typically, the PC card 120 additionally includes one or more interactive inputs, such as exterior functional input keys or control inputs 132-134. The function keys allow a user to interactively activate, access data and/or utilize the PC card as a stand alone device. The function keys can provide any number of functions, and a key can be configured to provide more than one function. For example, a function key can be a power button or switch that powers up the PC card for stand alone use. A key can be included that allows access to data on the PC card. A key can be included that allows data on the PC card to be manipulated (e.g., scrolled, page forward, deleted, etc.). A key can provide access to directories of data stored on the PC card. A key can provide access to an index of content and/or a table listing the contents of the PC card. A key can control volume if the stand alone PC card 120 is configured to deliver audio output. One or more keys can adjust display parameters when pictures or other data is display on the display 130. One or more keys can be buttons for making selection, such as selecting numbers, contents from a list or other similar functions. In one embodiment, the function keys can provide a mouse feature allowing the user to direct a pointer, highlight items or portions of items on the display and/or make selections from the display. The interactive input can additionally or alternatively include a touch mouse pad 138 (see FIG. 2) allowing the user to manipulate a pointer on the display by touching and/or sliding a finger or other object on the touch pad.

FIG. 2 depicts a simplified elevated view of a stand alone PC card 120 according to one embodiment of the present invention. The PC card is configured to be inserted into a host device 122 to allow the host device to utilize the functions and capabilities provided through the PC card. The PC card 120 can additional be configured to receive one or more additional external modules or devices 150, such as external memory storage devices, subunit or Memory Sticks®, GPS module, Bluetooth module, and other similar external modules. The external module 150 can contain digital images (for example, from a camera or video recorder), audio data, such as music, recorded audio (e.g., dictation or recordings of a meeting), digital game data (e.g., video game data), text data, graphical data and other similar data. One example of an external memory storage module is a Memory Stick® produced by the Sony Corporation of Japan.

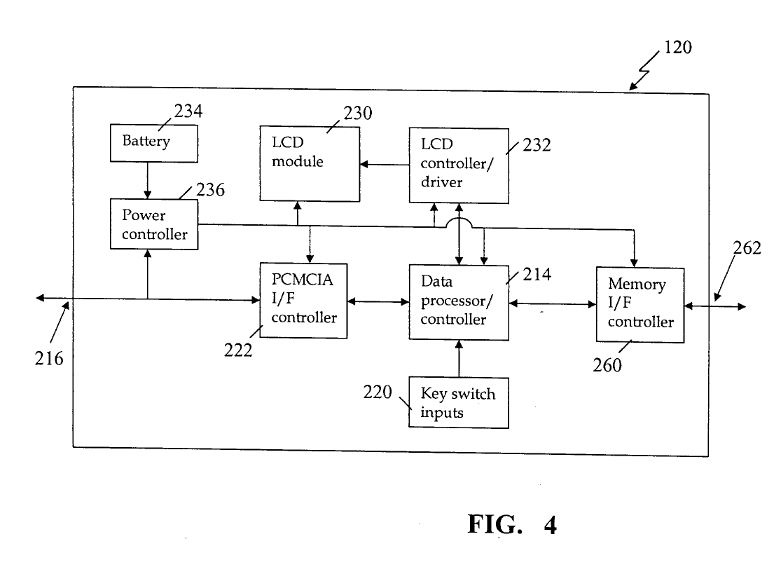

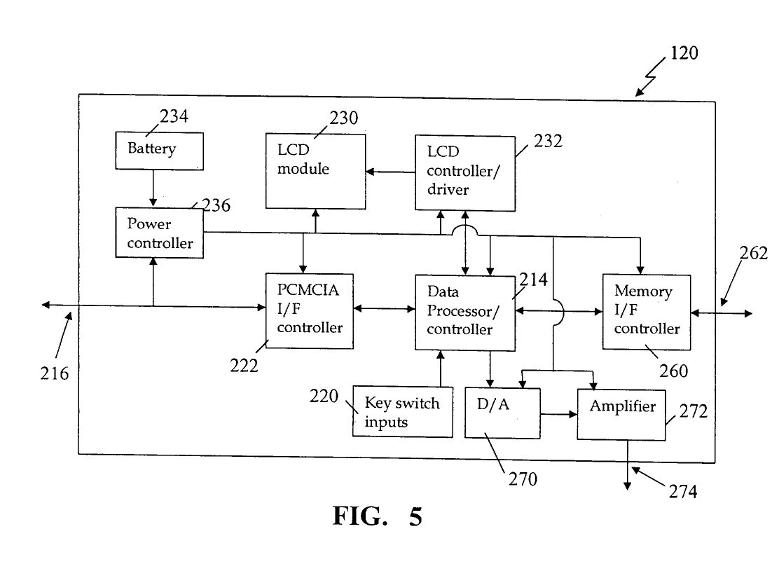

For example, the PC card 120 of FIG. 2 includes an external memory storage device port 152. The external memory port includes an interface (see FIGS. 4-5) to receive and couple with the external module 150. Any number of interfaces can be utilized to implement the coupling between the PC card and the external device 150. The PC card 120 is configured to access and utilize the functions of the external module and/or access data stored on the external module, as well as to supply that functionality and/or data to the host device 122 when cooperating with the host device. Alternatively, the PC card is configured to provide stand alone access to the functionality and/or data on the external module 150. For example, the PC card 120 can include a display 130, function keys 132-134 and touch pad 138. The external module 150 can be a memory device configured to store digital images or pictures. The PC card can display one or more of the images on the display 130 as directed through input from one or more of the function keys and/or touch pad. As another example, the external device can 150 be a GPS module. The PC card can directly access the GPS module to achieve wireless communication without the need to cooperate with the host device.

In some embodiments, the PC card 120 additional includes an audio output 156. The audio output can be a headphone jack or other output that can be electrically coupled with speakers or a wireless transmitter. Alternatively, the audio output can be a speaker or other device for directly emitting sound. In these embodiments the PC card can store audio data and/or include an external memory device port 152 for receiving an external memory device 150 containing audio data, such as music. This allows a user to access audio data directly from the stand alone PC card 120 without having to incorporate or cooperate the PC card 120 with a host device 122. Typically, music is stored onto the PC card and/or external memory subunit 150 (see FIG. 2) through the host device (e.g., personal and/or portable computer). Similarly, the music can be edited, organized, deleted and other similar operations through the host device.

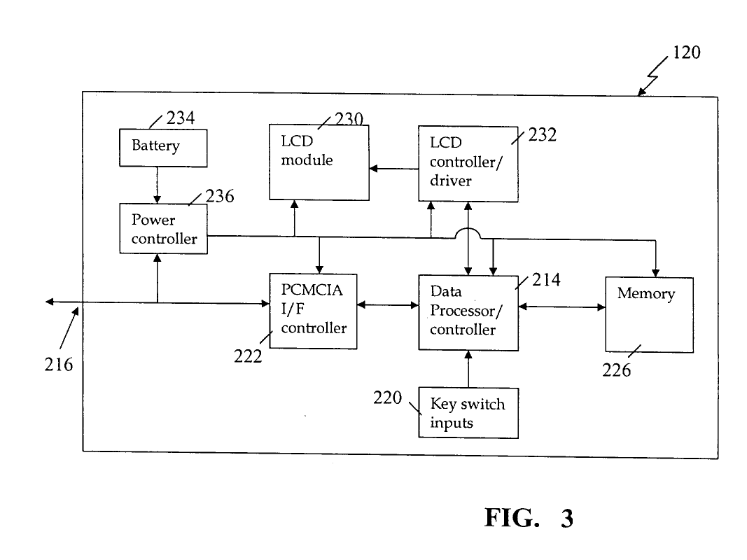

FIG. 3 depicts a simplified block diagram of a PC card 120 according one embodiment of the present invention, which can implement, for example, the PC card 120 shown in FIG. 1. The PC card 120 includes a data processor or controller 214. The data processor 214 provides control for the PC card and the components of the PC card. The data processor can be implemented through one or more microprocessors, state machines or other controllers. The implementation of the data processor 214 is dependent on the type of PC card and the intended use of the PC card (e.g., a memory PC card, a Bluetooth interface PC card, a GPS interface PC card, a network interface PC card or other similar PC cards).

Control of the PC card 120 is typically directed through one of two inputs, the host device interface 216 and the exterior interactive inputs 220 (e.g., function keys 132-134 and/or touch pad 138). The host device interface 216, as described above, can be substantially any interface for electrically couple and communicating with an external host device. For example, the interface 216 can include a multi-pin male or female connector. The host device interface couples with a host interface controller 222, such as a PCMCIA interface (I/F) controller. The host interface controller controls data communication between the PC card 120 and the host device as directed by the data processor 214. Data can be stored by the PC card in memory 226. The data processor 214 couples with the memory to direct the reading and/or writing of data from and/or to the memory.

In some embodiments, the PC card includes a display module 230, such as an LCD display module or other similar display modules. The display module is controlled through a display controller or driver 232. The display controller couples with the data processor 214 and displays data provided by the data process, retrieved from memory 226, or in some embodiments from the host device interface 216.

The PC card 120 includes a power source 234 that supplies power to the components of the PC card. The power source can be a rechargeable power source, a disposable power source or a combination of rechargeable and disposable, an adaptor or interface to utilize an external power (such as a standard wall power outlet), a solar power source or other power sources and/or combination of sources. The PC card 120 typically includes a power controller 212. The power controller distributes power to the components of the PC card as needed. The power controller can be implemented through any number of configurations well known in the art. The power controller couples with the power source 234 and the host device interface 216. The power controller distributes power from the power source 234 when the PC card 120 operates as a stand alone device. Alternatively, the power controller 236 typically draws power from the host device through the host device interface 216 when the PC card is coupled with the host device 122 (see FIG. 1). In some embodiments, the power controller can additionally draw power from the host interface 216 to recharge the power source 234 when the power source is a rechargeable power source.

FIG. 4 shows a simplified block diagram of a PC card 120 according to one embodiment of the present invention for implementing a PC card similar to that shown in FIG. 2. The PC card includes a data processor 214 that couples with function key inputs 220, an external host interface controller 222, a display controller 232, and an external interface controller 260, such as a memory interface controller. The PC card additionally includes a power controller 236 that distributes power to the components of the PC card 120 from the power source 234 or through the host device interface 216.

The memory interface controller 260 is configured to control the data flow between the PC card 120 and an external or supplemental memory interface and/or port 262. The supplemental memory interface 262 allows the PC card 120 to couple with supplemental memory, such as additional external memory storage devices, subunit or Memory Sticks® 150 (see FIG. 2). The data accessed through the through the memory interface 262 can be supplied to the interactive display module 230 to allow a user to view the data, the data can be supplied to the host device through the exterior host interface 216 and/or stored within the PC card.

FIG. 5 depicts a simplified block diagram of an alternative embodiment of a PC card 120 according to one embodiment of the present invention for implementing the PC card shown in FIG. 2. The PC card 120 includes a data processor 214 that couples with function key inputs 220, a host interface controller 222, a display controller 232, a memory interface controller 260, as well as a digital-to-analog (D/A) converter 270 and one or more amplifiers 272. The PC card additionally includes a power controller 236 that distributes power to the components of the PC card 120 from the internal power source 234 or through the host device interface 216.

The D/A converter 270 receives digital audio data from the data processor 214 and converts the data to an analog signal. The analog signal passes through the amplifier 272 to be amplified. The amplified audio signal is provided as an output to an audio output or interface 274. The audio output can couple with headphones, speakers, a receiver, external amplifier, wireless transmitter or other external devices configured to receive audio signals.

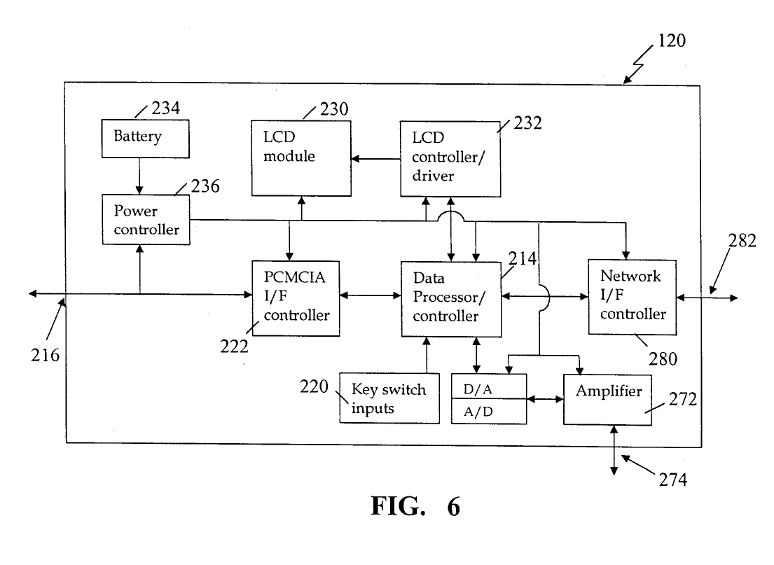

FIG. 6 depicts a simplified block diagram of an alternative embodiment of a PC card 120 according to one embodiment of the present invention for implementing the PC card shown in FIGS. 1 and/or 2. The PC card 120 includes a data processor 214 that couples with one or more function key inputs 220, a host interface controller 222, a display controller 232 and a display 230. The display controller is implemented through substantially any display controller, such as any one of numerous commercially available display controllers. In some embodiments, the PC card further includes a digital-to-analog (D/A) converter 270 and one or more amplifiers 272. The PC card additionally includes a power controller 236 that distributes power to the components of the PC card 120 from the internal power source 234 or through the host device interface 216.

The PC card 120 additionally includes an external interface controller, such as a network interface controller 280, and an external interface, such as an external network interface 282. The network interface controller 280 allows data to be communicated between the PC card and an external network, such as an intranet, the Internet, wireless networks or other similar networks and combinations of networks. The network interface 280 can additionally be a wireless communication interface to a wireless communication network (e.g., providing GPS communication) or other communication interface (e.g., allowing the PC card to act as a modem).

Because the PC card 120 can operate as a stand alone device, and utilizing the network interface controller 280 and network interface 282, the PC card can allow a user to directly communicate from the PC card without the need for a host device or computer. For example, the PC card can be utilized to directly establish wireless communication when the network interface controller 280 is configured as a wireless communication interface controller providing wireless communication. The function keys 220 can include keys to allow dialing of phone numbers. Alternatively or additionally, the function keys can be used to select numbers displayed on the display 230.

Additionally, the audio interface 274 can be a bi-directional interface. As such, a user can couple a microphone and speaker to the audio interface 274. This allows the user to implement the stand alone PC card 120 as a phone. The network interface controller 280 can be configured for wireless communication or be configured as a modem to establish wired communication over phone lines or other wired communication links. The PC card 120 can operate as a stand alone to provide the communication without the need for a host device. However, the PC card is further configured to operate in concert with the host device to provide communication to and from the host device, similar to those of previous PC cards.

While the invention herein disclosed has been described by means of specific embodiments and applications thereof, numerous modifications and variations could be made thereto by those skilled in the art without departing from the scope of the invention set forth in the claims.

What is claimed is:

1. A Personal Computer Memory Card International Association (PCMCIA) card, comprising:
a host device interface configured to interface with an external host device;
an internal power source;
an interactive output; and
an interactive input.

2. The PCMCIA card as claimed in claim 1, further comprising:
a memory port configured to receive an external memory storage device.

3. The PCMCIA card as claimed in claim 2, wherein the interactive output includes a display for displaying at least a portion of data accessible through the PCMCIA card.

4. The PCMCIA card as claimed in claim 1, wherein the interactive output includes an audio output for outputting audio data.

5. The PCMCIA card as claimed in claim 4, further comprising internal memory for storing data, wherein the interactive output includes a display that is configured to display at least a portion of the data stored in the internal memory.

6. The PCMCIA card as claimed in claim 1, wherein the interactive input includes at least one exterior function key configured to receive user commands for operational control.

7. A Personal Computer Memory Card International Association (PCMCIA) card, comprising:
a host device interface configured to allow the PCMCIA card to interface with a host device;
a PCMCIA card output;
a data processor configured to provide control over output directed to the PCMCIA card output; and
an external interface controller configured to control data communication to and from the PCMCIA card.

8. The PCMCIA card as claimed in claim 7, wherein the external interface controller includes an external memory interface controller configured to control the data communication between the PCMCIA card and an external memory storage device.

9. The PCMCIA card as claimed in claim 7, wherein the external interface controller includes a network interface controller configured to control the data communication between the PCMCIA card and an external network.

10. The PCMCIA card as claimed in claim 9, wherein the network interface controller includes a wireless communication interface controller configured to control the data communication between the PCMCIA card and a wireless communication network.

11. The PCMCIA card as claimed in claim 7, wherein the PCMCIA card output includes a display configured to display data as directed by the data processor.

12. The PCMCIA card as claimed in claim 7, wherein the PCMCIA card output includes an audio output.

13. The PCMCIA card as claimed in claim 7, further comprising an audio input configured to receive externally generated audio input data.

14. An apparatus for interfacing with a host device, comprising:
a data processor configured to provide data processing within the apparatus;
a host device interface;
a direct apparatus output; and
a functional input coupled with the data processor, wherein the function input directs at least a portion of the operation of the data processor.

15. The apparatus as claimed in claim 14, wherein the direct apparatus output includes an audio output.

16. The apparatus as claimed in claim 15, further comprising an audio input.

17. The apparatus as claimed in claim 15, wherein the direct apparatus output includes a display.

18. The apparatus as claimed in claim 14, further comprising an external memory device interface configured to interface with an external memory for communicating data between the apparatus and the external memory.

19. The apparatus as claimed in claim 14, further comprising a network interface configured to interface with an external network for communicating data between the apparatus and the network.

20. The apparatus as claimed in claim 14, wherein the functional input includes a plurality of function keys.
